(19) United States
(12) Patent Application Publication
(10) Pub. No.: US 2007/0288947 A1
(43) Pub. Date: Dec. 13, 2007

(54) SWING ARM OPTICAL DISC DRIVE

(75) Inventor: David Livshits, Ashdod (IL)

Correspondence Address: BROWDY AND NEIMARK, P.L.L.C.;624 NINTH STREET, NW, SUITE 300, WASHINGTON, DC, 20001-5303, US

(73) Assignee: MemPile Inc., Wilmington, DE (US)

(21) Appl. No.: 11/760,184

(22) Filed: Jun. 8, 2007

Related U.S. Application Data
(60) Provisional application No. 60/804,176, filed on Jun. 8, 2006.

(51) Int. Cl. G11B 7/00

(52) U.S. Cl. 720/662

(57) ABSTRACT

Disclosed is a swing type optical disc drive. The drive includes a disc rotating on a disc support and a swing arm pivoted at one of its ends and having a distal end communicating with an encoder. The pivot point and a point on distal end define a swing axis of the arm. The disc further includes an optical system mounted on the arm such that optical axis of the system is parallel with the swing axis and both axes lie in the same plane. A cam actuator imparts a swinging motion to the arm. The swinging motion of the arm positions the plane with the optical axis and the arm axes such that the plane is always tangent to a reading/recording track of the disc.

### FIELD OF THE INVENTION

This invention is generally in the field of optical information carriers and associated drives, and relates to a swing arm optical disc drive.

### BACKGROUND OF THE INVENTION

Optical storage is one of the most popular information storage methods. The information or data is stored in a disc like body in the form of a pattern of data marks or symbols recorded along so-called data tracks to be readable by an optical beam. The tracks may have the form of concentric rings or one long spiral track. Each disc contains thousands of concentric rings. For reading or recording purposes, the disc is mounted on a rotating support. A read/record optical pick-up unit (OPU) scans across the rotating disc for reading or recording information from/in the tracks. Typically, an actuator provides a scanning movement of the OPU moving it from track to track or along the spiral track. The actuator may be of linear or rotary type. A linear actuator translates along a single axis radially relative to the disc axis. A rotary actuator pivots on rotary bearings and the OPU swings over the disc in a type of an arcuate movement. Some of the rotary actuator systems are described in the U.S. Pat. Nos. 5,153,870 and 6,449,225.

Conventional single- or double-layer discs have reflecting layers in which the data is recorded in the form of pits or as a change of some physical properties of the layer. The data is generally accessed (read) when the disc is illuminated with an optical beam, typically a laser diode beam. The reflective properties of the layer in conventional discs are utilized for reading and do not require high optical power. Data recording in such discs also does not require high power. Low-power laser diodes are small and lightweight devices that are integrated in the OPU. Such disc drives are termed integrated OPUs.

In order to significantly increase the storage capacity, multi-layer discs have been developed in which a data layer is an optically transparent layer containing an array of spaced-apart fluorescent regions. One type of such fluorescent optical storage is disclosed for example in U.S. Pat. Nos. 6,039,898 and 6,309,729.

Another type of non-reflective multi-layer optical storage has been developed and is disclosed for example in U.S. Pat. No. 7,011,925, assigned to the assignee of the present application. These discs utilize a nonlinear media in which at least one of the data reading and writing methods involve multi-photon interaction. As a result, the recorded data is in the form of a three-dimensional pattern of spaced-apart recorded regions. The information can be recorded and/or read with three-dimensional resolution (as opposed to the two-dimensional resolution afforded, for example, by magnetic tape or CD). This technique can provide terabyte-level data storage. Data recording and readback are achieved by focusing lasers within the medium. However, because of the volumetric nature of the data structure, the laser light must travel through many data points before it reaches the point where reading or recording is desired. Therefore, nonlinear technology is required to ensure that these other data points do not interfere with the addressing of the desired point.

### GENERAL DESCRIPTION

Optical discs using non-linear storage medium which are referred to herein as “three-dimensional optical discs” or “three-dimensional storage media”, require significant optical power for both data reading and recording. Powerful laser diodes provide the required power, although they require special cooling conditions to dissipate some of the heat generated and bulky electrical armature. As a result of these requirements, housings containing laser diodes with all the necessary equipment become large and heavy, and complicate their integration in the OPU. Generally, this problem can be solved by mounting the laser diode units outside the actuator, which will contain a so-called split optical system including only a lightweight and small OPU, while the rest of the optical elements forming the optical drive system are mounted on a separate support.

Three-dimensional storage media, although implemented to be compatible in diameter with conventional compact discs (CDs), may have thickness and weight substantially larger than those of the conventional CDs or DVDs. Using some of the parts of the split optical systems located on a separate support might result in that vibrations cause a relative movement between the parts of the system making it difficult and sometimes impossible to provide the type of micron accuracy required for accurate optical data reading and recording.

Therefore, there is a need in the art to provide a novel driving mechanism including an integrated optical system mounted on a swing arm for moving an optical pick up (OPU) along a reading/recording surface of an optical disc to reproduce or read data recorded on the optical disc with micron accuracy.

Thus, according to one broad aspect of the invention, there is provided a driving mechanism for optical discs, the driving mechanism comprising: a swing arm extending along a swing axis and configured and operable to pivot about a pivot point located at a proximal end of the swing arm; an integrated optical system mounted on said swing arm and comprising a light source unit located at the proximal end of said arm, an optical guiding system for guiding light from the light source unit towards an optical pick-up unit comprising focusing and collecting optics; the optical elements of the integrated optical system being arranged in a spaced apart relationship along said swing arm defining an optical axis parallel to said swing axis.

In some embodiments, the elements of the integrated optical system are at a fixed position with respect to the swing and optical axes during the swing arm movement. The optical guiding system comprises a collimating and folding optics configured and operable to selectively shift the optical axis of the light propagation such that said optical axis, said swing arm axis and the shifted optical axis of the light propagation are all in the same plane tangent to a recording/reading track. It should be noted that the collimating optics might be a collimating lens located on the proximal end of the swing arm at the output of the laser source (laser diode) and operable to direct the light propagation to the folding optics element.

Preferably, the folding optics includes a folding reflector configured and operable to deflect the light beam in a direction perpendicular to the optical axis. The optical pick-up unit is located on the swing arm at a predetermined distance L₁ from the pivot point such as to provide a predetermined ratio L₁/L, L being the swing arm length, for improving accuracy of scanning spot movement along the disc.

In some embodiments, the driving mechanism comprises a cam-like mechanism for activating the movement of the swing arm. The diameter and eccentricity of the cam are selected such that in one rotation of said cam the swing arm crosses the entire recordable section of the disc. Preferably, the eccentricity of said cam is about a half of the disc recordable section.

The light source unit may comprise at least one laser diode. The laser diode is a high-power light source operable with average power higher than 300 mw. The light source unit may also comprise a cooling element mounted on the swing arm configured and operable to dissipate heat generated by a light source unit or by the laser diode.

In some embodiments, the driving mechanism comprises a control unit configured and operable for controlling the movement of the swing arm and the light propagation scheme towards the disc. The control unit comprises an encoder configured and operable to track the position of the swing arm. The encoder may be mounted on the distal end of the swing arm.

According to another aspect of the invention, there is provided an optical disc drive comprising: an integrated optical system comprising a light source unit comprising one or more high-power laser diodes, an optical pick-up unit spaced apart from the light source unit and comprising focusing and collecting optics, and an optical guiding system for guiding light from the light source unit towards the optical pick-up unit; a swing arm extending along a swing axis and configured and operable to pivot about a pivot point located at a proximal end of the swing arm; the optical elements of the integrated optical system being arranged in a spaced apart relationship along said swing arm defining an optical axis parallel to said swing axis.

### BRIEF DESCRIPTION OF THE DRAWINGS

In order to understand the invention and to see how it may be carried out in practice, a preferred embodiment will now be described, by way of non-limiting examples only, with reference to the accompanying drawings, wherein:

FIG. 1 is a simplified schematic view of an optical disc drive according to an embodiment of the present invention;

FIGS. 2 and 3 are schematic top and perspective views, respectively, of an example of a driving mechanism suitable to be used in the system of FIG. 1.

### DETAILED DESCRIPTION OF EXEMPLARY EMBODIMENTS

The configuration and operation of the optical disc drive and the driving mechanism used therein can be better understood with reference to the drawings, wherein like reference numerals denote like elements through the several views and the accompanying description of non-limiting, exemplary embodiments.

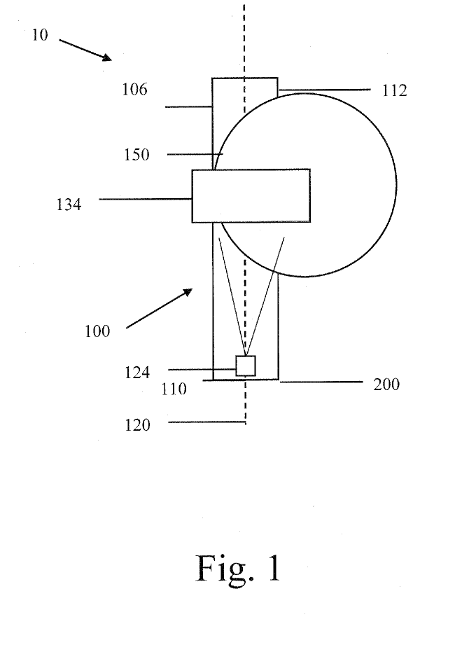

Reference is made to FIG. 1, exemplifying an optical disc drive system, generally designated 10, for recording/reading data in an optical disc 150 mounted on a rotatable disc support (not shown here). The drive system 10 includes a driving mechanism 100 including a swing arm 106 configured for pivotal movement about a pivot point or axis 110 and for carrying an integrated optical system which includes a light source unit 124 and an optical pick-up unit (OPU) 134 including focusing and collecting optics. The swing arm 106 extends along a swing axis 120 and has a proximal end 200 and a distal end 112. The light source unit 124 is located at the proximal end 200 of the swing arm 106 close to the pivot point 110, being spaced from the optical pick-up unit (OPU) 134. Thus, all the optical elements of the integrated optical system are arranged in a spaced apart relationship along the swing arm 106 defining an optical axis (not shown here) parallel to the swing axis 120, with the light source unit 124 located outside the OPU 134.

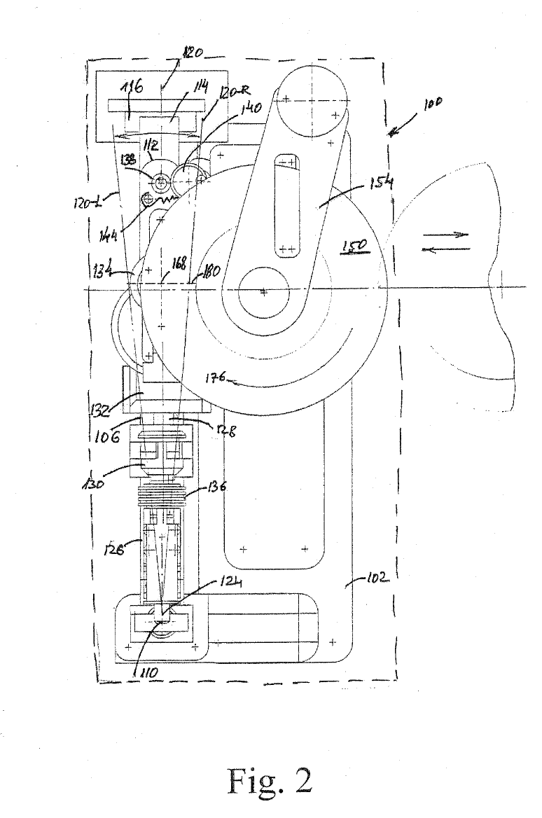

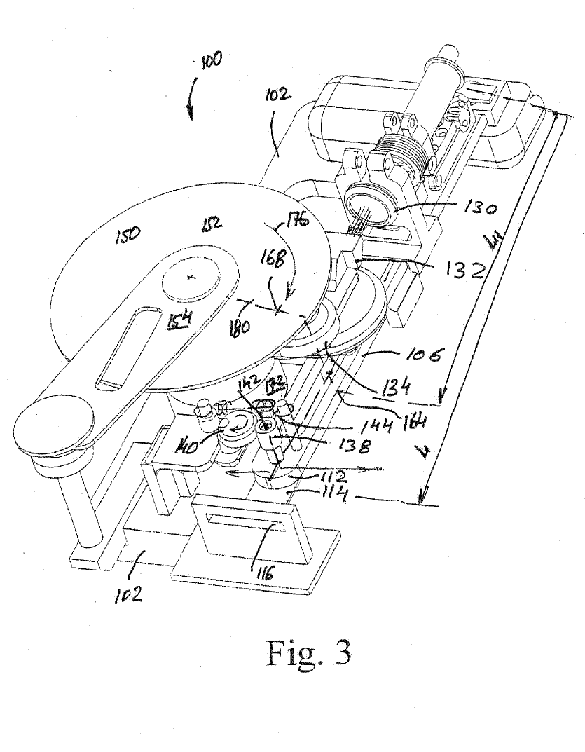

Reference is made to FIGS. 2 and 3, showing an example of the configuration of the driving mechanism 100. The driving mechanism 100 includes a rigid frame 102, which serves as a mount for different drive components. The swing arm 106 of a certain length L extends along the frame 102 and is pivotally mounted on the frame 102 about the pivot 110, which serves as an axis around which the arm 106 may swing. Further provided is a control mechanism, which includes an encoder 116. A flag 114 communicating with the encoder 116 terminates the distal end 112 of the swing arm 106. A line passing through the pivot 110 and a middle of the distal end 112 of the swing arm 106 and the flag 114 defines the swing axis 120 of the arm 106. The swing arm 106 carries at its proximal end the light source unit 124 including a high power diode laser or a similar light emitter located in a housing 126 and configured for producing a recording/reading beam 128. Further mounted on the swing arm 106 is an optical guiding system for guiding light from the light source unit towards the optical pick-up unit 134. The light guiding system includes a laser beam shaping optics 130 and a folding reflector (mirror) 132 or a dichroic beam splitter. All the above optical elements are mounted on the swing arm 106 such that they have all necessary freedoms of movement required for optical adjustment of the system. The optical elements can be adjusted on the swing arm 106 for calibration either during manufacturing by using screws or during the operation of the driving mechanism 100 by using an additional linear actuator mounted on the swing arm 106.

Closer to the distal end 112 of the swing arm 106, a free rotating ball or roller bearing 138 is mounted being in contact with a cam-like element 140. The permanent contact between the bearing and the cam is maintained by a spring 144, which also provides a preload eliminating backlash that may be present in the driving mechanism 100. Rotation of the cam 140 imparts a swing type motion on the arm 106. Lines 120-L and 120-R schematically show a range of the swing movement.

Preferably, the diameter and eccentricity of the cam 140 are selected such that one rotation of the cam 140 results in the swing arm 106 crossing (scanning) the entire recordable section of the disc 150 radius. To this end, the eccentricity of the cam 140 is about a half of the disc recordable width (section). For example for a 120 mm disc with the recordable width of 37 mm, the eccentricity of the cam 140 would be 18.5 mm.

The crossing of the swing axis 120 with a swing trajectory line 180 schematically shows the zero position of the swing arm. Actually, this crossing indicates the position of a reading/recording spot 168.

As indicated above, the driving mechanism 100 includes a control unit which, in addition to the encoder 116 includes an appropriate servo system or a control utility, adapted for controlling the movement of the swing arm 106 and the light propagation scheme towards the disc 150. Encoder 116 tracks the movement of the distal end of the arm 106 and provides position feedback to the control utility.

As shown in FIG. 2, the driving mechanism may also include other components, such as a disc loading and holding lever 154.

The components of the optical system mounted on the swing arm 106, namely the high-power laser diode unit 124, laser beam shaping optics 130, folding mirror 132, and OPU 134, are adjusted such that the optical axis 160 defined by the light propagation from the laser diode towards the OPU is substantially parallel to the centerline (swing axis) 120 of the arm 106. This type of adjustment provides a rigid connection between all the optical components of the optical system and the swing arm 106. Not all the optical components are rigidly fixed to the swing arm 106 during the operation of the driving mechanism 100 but remain substantially static on the swing arm 106 in course of the swing movement. The light propagation axis 160 of the optical system and the swing axis 120 of the arm 106 become also rigidly connected. Thus, the disturbances that may be generated by vibration of a split optical system, in which only a lightweight and small OPU is mounted on the actuator and the rest of the optical elements forming the system are mounted on a separate support are eliminated. The disturbances are substantially eliminated by the rigid connection provided between the optical elements and the swing arm 106 during the swing arm movement.

Folding reflector 132 may be a single mirror or an assembly of few mirrors as required by a particular drive design. Laser beam shaping optics 130 is configured for collimating the laser beam 128. Laser beam shaping optics 130 may be a simple or variable collimation and magnification system capable of changing the divergence of the recording/reading beam 128 and the position of a focused spot within disc 150. Alternatively, a conventional OPU may be used operable to refocus the spot within the disc 150. Folding mirror 132 shifts the light propagation axis 160 of optical system at about 90 degrees, such that the OPU can focus the beam 128 onto the disc 150. The so-shifted or folded optical axis remains in the same plane tangent to a recording/reading track 180 as the optical system axis 160 and the swing axis 120, and as shown by phantom line a downward extension 164 of the shifted axis 160-a in a direction in which the swing axis 120 would cross it.

It should be noted that the light source unit 124 may include a selective wavelength light director configured to produce at least two light beams. These may be recording and reading beams of different wavelengths, or reading/recording beam(s) and a reference beam (in case the disc medium includes one or more reference layers). The case may be such that the first light beam is of a wavelength range suitable for recording/reading in the disc media and a second, reference light beam is of a suitable wavelength range (which may be different or not from that of the recording/reading beam). The disc drive system may include at least two different light emitters operating with different wavelength ranges. For example, the first beam source (light emitter), being a powerful source configured and operable to produce a record/retrieve beam, is located in the light source unit 124 outside the OPU 134, while an additional light emitter, being a standard power source for the reference beam generation (to track the reference layer) might be located in the OPU 134. The folding reflector 132 may also be a dichroic mirror integrating the two light beams.

Preferably, the OPU 134 is mounted on the arm 106 at about 90 degrees to the optical axis 160 such that the shifted (folded) optical axis 160-a that defines the position of disc reading/recording spot, crosses the swing axis 120.

The OPU is spaced from the pivot point 110 at the proximal end 200 a distance L₁. The arrangement is such that the swing movement of the distal end 112 and associated with it axis 120 is larger by a ratio of L/L₁ than the movement of the spot 168 focused by the OPU 134. Encoder 116 tracks the movement of the distal end 112 of the arm 106. The accuracy of determination of the spot 168 position is higher than the distal end 112 position determination (tracking) accuracy at the same ratio. Cam 140 needs to apply a relatively small force to the swing arm 106 around the pivot 110. The relative position of the cam 140 with respect to the pivot 110 and the length of the swing arm 106 allow development of a large moment, no matter how heavy are the components mounted on the arm 106. For example, FIG. 2 shows the laser diode housing 126 implemented as a cylinder with thick walls and having a heat sink 136. The accuracy of the swing movement and the moment developed by the forces applied by the cam 140 may be selected by varying the L/L₁ ratio.

For reading or recording purposes, the lever 154 picks up the disc 150 and inserts it in the drive system (10 in FIG. 1). Lever 154 remains engaged with the disc 150 as long as the disc is in use, providing additional support for relatively thick and heavy three-dimensional discs made of non-linear optical materials. A rotatable support 172 (FIG. 3) rotates the disc 150 in a direction indicated by arrow 176. At the same time, the laser diode 124 is activated, and the OPU operates to create the scanning spot 168 on the desired layer in the disc 150. Servo controlled change of magnification of the collimating optics 130 allows to position the spot 168 at the desired depth or layer within the disc 150. Alternatively, a servo controlled conventional OPU may refocus the spot 168 at the desired depth (layer). Swing of the arm 106 scans the spot 168 in a type of arcuate movement across the selected layer. Rotation of the cam 140 imparts the swinging movement on the arm 106. Line 180 illustrates the spot 168 movement on the recording/reading layer. Encoder 116 communicates the arm 106 and accordingly the spot 168 coordinates to a servo system or control utility. At any given time of the drive operation, the centerline (swing axis) 120 of the arm 106, the optical axis 160 and the folded optical axis 160-a remain in the same plane, which is tangent to any of the reading/recording tracks 180.

In course of the disc operation, the arm 106 moves in a swing type motion, although all optical elements mounted on it at any time are static with respect to the arm 106, swing axis 120 and optical axis 160. The plane that contains the swing axis 120, optical axis 160, and folded optical axis 160-a always remains tangential to any reading/recording track 180 that it writes or reads at the particular moment.

The above technique always maintains the position of the optical axis in the same plane. This does not generate distortions related to the relative movement between the optical components. The weight of laser diode unit does not affect the system operation, no vibrations are transferred to the optical system, and no optical laser beam jitter exists. The disclosed optical system has all the advantages of an integrated optical system combined with the advantages of a split system.

While the exemplary embodiment of the present drive system and drive mechanism used therein has been illustrated and described, it will be appreciated that various changes can be made therein without affecting the spirit and scope of the invention. The scope of the invention is defined by reference to the following claims:

1. A driving mechanism for optical discs comprising:
a) a swing arm extending along a swing axis and configured and operable to pivot about a pivot point located at a proximal end of the swing arm;
b) an integrated optical system mounted on said swing arm and comprising a light source unit located at the proximal end of said arm, an optical guiding system for guiding light from the light source unit towards an optical pick-up unit comprising focusing and collecting optics; the optical elements of the integrated optical system being arranged in a spaced apart relationship along said swing arm defining an optical axis parallel to said swing axis.

2. The driving mechanism of claim 1, wherein elements of the integrated optical system are at a fixed position with respect to the swing and optical axes during the swing arm movement.

3. The driving mechanism of claim 1, wherein said optical guiding system comprises a collimating and folding optics configured and operable to selectively shift the optical axis of the light propagation such that said optical axis, said swing arm axis and the shifted optical axis of the light propagation are all in the same plane tangent to a recording/reading track.

4. The driving mechanism of claim 1, wherein the folding optics includes a folding reflector configured and operable to deflect the light beam in a direction perpendicular to said optical axis.

5. The driving mechanism of claim 1, wherein the optical pick-up unit is located on the swing arm at a predetermined distance L₁ from the pivot point such as to provide a predetermined ratio L₁/L, L being the swing arm length, for improving accuracy of scanning spot movement along the disc.

6. The driving mechanism of claim 1, comprising a cam-like mechanism for activating the movement of said swing arm.

7. The driving mechanism of claim 6, wherein diameter and eccentricity of said cam are selected such that in one rotation of said earn said swing arm crosses the entire recordable section of the disc.

8. The driving mechanism of claim 7, wherein the eccentricity of said cam is about a half of the disc recordable section.

9. The driving mechanism of claim 1, wherein said light source unit comprises at least one laser diode.

10. The driving mechanism of claim 9, wherein said at least one laser diode is a high-power light source operable with average power higher than 300 mw.

11. The driving mechanism of claim 1, wherein the light source unit comprises a cooling element mounted on said arm configured and operable to dissipate heat generated by a light source unit.

12. The driving mechanism of claim 9, wherein the light source unit comprises a cooling element mounted on said arm configured and operable to dissipate the heat generated by the laser diode.

13. The driving mechanism of claim 1, comprising a control unit configured and operable for controlling the movement of the swing arm and the light propagation scheme towards the disc.

14. The driving mechanism of claim 13, wherein said control unit comprises an encoder configured and operable to track the position of said arm.

15. The driving mechanism of claim 14, wherein said encoder is mounted on the distal end of said swing arm.

16. An optical disc drive comprising:
an integrated optical system comprising a light source unit comprising one or more high-power laser diodes, an optical pick-up unit spaced apart from the light source unit and comprising focusing and collecting optics, and an optical guiding system for guiding light from the light source unit towards the optical pick-up unit;
a swing arm extending along a swing axis and configured and operable to pivot about a pivot point located at a proximal end of the swing arm;
the optical elements of the integrated optical system being arranged in a spaced apart relationship along said swing arm defining an optical axis parallel to said swing axis, a plane containing the swing and optical axes being tangent to a reading/recording track of said disc produced by the optical system while scanning the disc.
